(19) United States
(12) Patent Application Publication
(10) Pub. No.: US 2005/0028848 A1
(43) Pub. Date: Feb. 10, 2005

(54) Contact lens cleansing unit

(76) Inventor: Jung-Hua Lai, Taipei Hsien (TW)

Correspondence Address: Jung-Hua Lai, P.O. Box No. 6-57, Junghe, Taipei 235, TW

(21) Appl. No.: 10/632,981

(22) Filed: Aug. 4, 2003

(51) Int. Cl. B08B 3/12

(52) U.S. Cl. 134/184

(57) ABSTRACT

A contact lens cleansing unit and consists of a body proper, a container unit, and a motorized unit. The body proper includes an outer shell, an inner lid, a base, and an outer lid. The outer shell is divided into an upper and a lower compartment in between which is a positioning hole. The inner lid is placed on the upper compartment having a frame for the container unit. The container unit has a sensor and a lens rack is placed within the frame on the upper compartment. The motorized unit contains the UV light affixed to the positioning hole of the upper compartment while a circuit board is placed in the lower compartment. The invention is able to achieve total cleaning and disinfecting through the combination of UV light and sub-ultrasonic vibrations plus ease of maintenance should the UV light bulb become defective.

### BACKGROUND OF THE INVENTION

(a) Field of the Invention

The invention relates to a contact lenses cleansing unit using low-frequency, sub-ultrasonic vibrations for cleaning and disinfecting to protect contact lenses from damages. By the opening and closing actions of a lid, switching on and off is achieved for safety.

(b) Description of the Prior Art

According to U.S. Pat. No. 5,144,144, the corresponding “contact lens cleaning/disinfecting system” consists of an upper cover and a lower base to form a motorized unit. The upper cover has a UV light while the lower base includes a cleaning/disinfecting chamber for saline, a supporting rod, a current generator, and an electronic control for the UV light and the current generator. The supporting rod is a pair of a lower rod for the lenses and a higher rod for prevention of UV radiation. The current generator is a magnetic pad fastened to the end of a spring and rotated to generate current to remove microbes, thins films, and other sediments on the lenses where UV radiation disinfection also takes place. The pad vibrates around 50˜120 cyc/sec. The current cleans the sediments on the lenses; there is no need to use hand or chemical cleanser. UV disinfects the removed sediments and the liquid without using heat, preservatives, or disinfectants.

Although the aforesaid contact lens cleaning/disinfecting system can accomplish the job of cleaning and disinfecting, but the vibrations are unstable and easily shifted, plus the liquid current is not effective. Moreover, the top lids are elastic for opening and closing. With passing of time, the elasticity will weaken. When the surface becomes dirty, conductivity weakens as well. If a UV light bulb is broken, the whole upper unit must be replaced along with the bulb thus increasing the cost and inconvenience. Improvement has become necessary.

After repeated researches and testing, the inventor has finally devised the new contact lens cleansing unit for improved cleaning and disinfecting.

### SUMMARY OF INVENTION

The invention consists of a body proper, a container unit, and a motorized unit. The body proper includes an outer shell, inner lid, base, and an outer lid. The outer shell is divided into an upper and a lower compartment in between which is a positioning hole. The inner lid is placed on the upper compartment which has a frame for the container unit. The container unit which has a sensor and a lens rack is placed within the frame on the upper compartment. The motorized unit which contains a UV light and a circuit board is placed in the lower compartment. The UV light is affixed in place to the positioning hole of the upper compartment. The circuit board includes a power plug, diodes, a magnetic strip, a capacitor, and indicator lights. The positive and negative diodes are placed under the UV light for powering up the light. The magnetic strip is placed under the container unit.

The object of the invention is to achieve total cleaning and disinfecting through the combination of UV light and sub-ultrasonic vibrations plus ease of maintenance should the UV light bulb become defective.

Another goal of the invention is to achieve safety of use through a hollow tube between the upper and lower compartments. The tube has a first through hole matching a second through hole. Under the inner lid there is a plate. An infrared electric control is on the circuit board within a hollow tube on top of which is a sensor connected to the first and second through holes. When the lid opens or closes the plate along with sensor switches on and off.

To enable a further understanding of the said objectives and the technological methods of the invention herein, the brief description of the drawings below is followed by the detailed description of the preferred embodiment.

### BRIEF DESCRIPTION OF THE DRAWINGS

FIG. 1 shows a perspective exploded view of the entire structural combination according to the invention.

FIG. 2 shows a cross-sectional schematic view of the completely assembled unit according to the invention.

FIG. 3 shows a frontal cross-sectional view of the complete assembly with the plate intact according to the invention.

FIG. 4 shows a side cross-sectional view of the complete assembly with the plate open for disconnection of power according to the invention.

### DETAILED DESCRIPTION OF THE PREFERRED EMBODIMENTS

To better understand the characteristics and novelties of the invention, descriptions shall be given with the accompanying drawings hereunder.

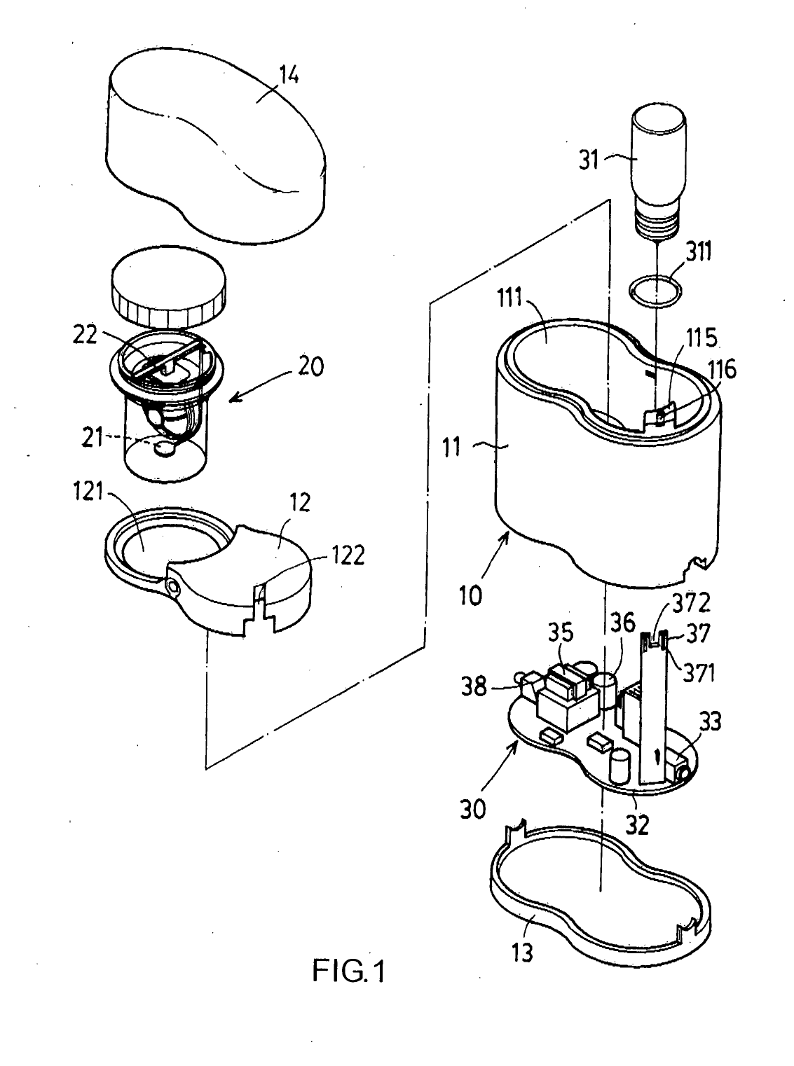

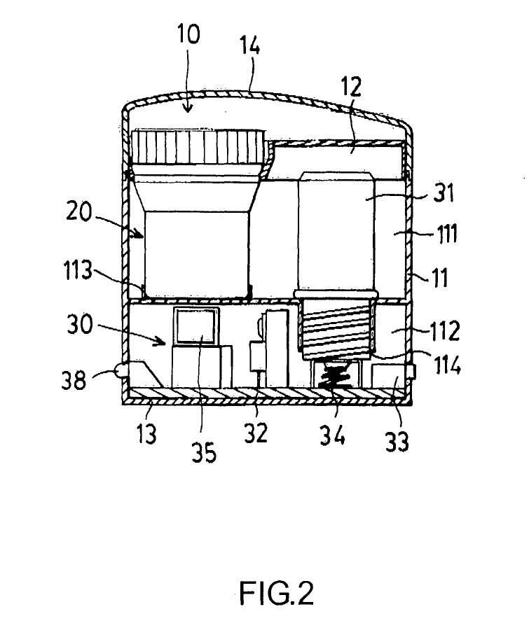

Referring to FIGS. 1˜2, the invention showing a cleansing unit consists of a body proper (10), a container unit (20), and a motorized unit (30).

The body proper (10) includes an outer shell (11), an inner lid (12), a base (13), and an outer lid (14). The outer shell (11) is divided into an upper compartment (111) and a lower compartment (112). On the bottom of the upper compartment (111) is a position fixing ring (113) and a positioning hole (114) to connect to the lower compartment (112) through a hollow tube (115). On top of the hollow tube (115) is a first through hole (116). The inner lid (12) is affixed to the upper compartment (111) and matching the outer shell (11) is the position fixing ring (113) for the frame (121) to correspond to the first through hole (116) and a second through hole (122) of the hollow tube (115). The base (13) is affixed to the bottom of the outer shell (11). The outer lid (14) can cover the top of the outer shell (11). Under the outer lid (14) is a plate (141) connected to the first through hole (116) as shown in FIG.

3. Under the Plate is a Insulator (142)

The container unit (20) is placed within the position fixing ring (113) through the frame (121). Inside the unit is a sensor (21) and a lens rack (22). Cleaning liquid can be poured into the container unit (20).

The motorized unit (30) is placed within the lower compartment (112) under the outer shell (11). An UV light (31) and a circuit board (32) are cased in the motorized unit (30). Under the UV light is an elastic ring (311) fixed to the positioning hole (114) of the upper compartment (111). The circuit board (32) is controlled by a distributing crystal and CPU and includes, a power plug (33), diodes (34), a magnetic strip (35), capacitors (36), an infrared control unit (37) and an indicator light (38). The power plug (33) and the indicator light (38) are exposed outside the outer shell (11). The positive and negative diodes (34) are placed under the UV light (31) to power up the light (31). The magnetic strip (35) is placed under the container unit (20). The capacitors (36) boost voltage to 40v and down to 20v after the UV light (31) is turned on. The infrared control unit (37) is placed within the hollow tube (115), on top of which are two sensor controls (371). In between the sensor controls (371) is a slot (372) that matches the first through hole (116).

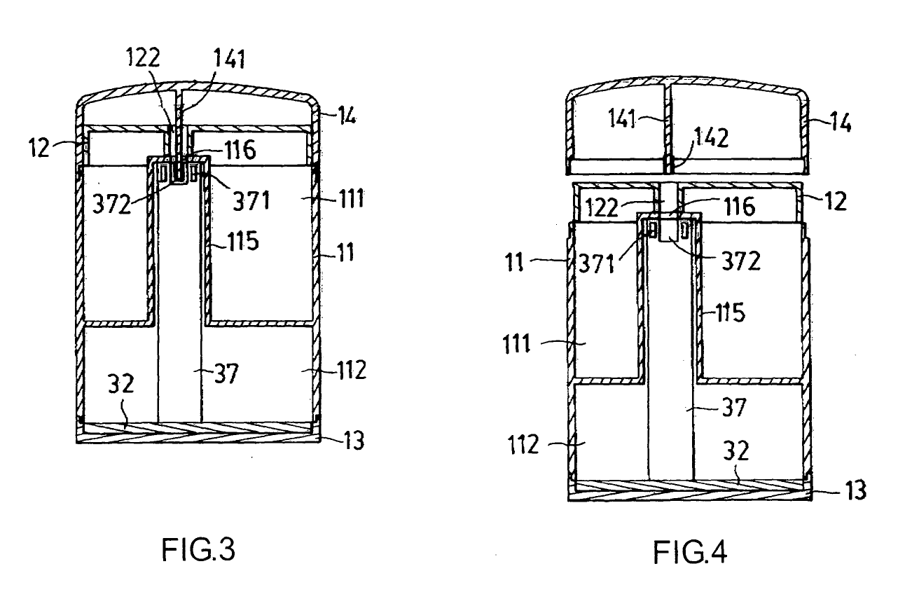

Referring to FIGS. 3˜4, when the outer lid (14) is closed on the outer shell (11), the plate (141) under the outer lid (14) is slid into the slot (372) between the two sensor controls (371) for electricity conduction when the power plug (33) is plugged. Vice versa, when the plate (141) under the outer lid (14) comes off the slot (372), power is disconnected to prevent discomfort after the outer lid (14) is opened and to improve usage safety.

After contact lenses are placed into the lens rack (22) of the container unit (20) of the aforesaid cleansing unit and the cleaning liquid is poured into the container unit (20), the contact lenses are cleaned and disinfected by the actions of the motorized unit (30) which, when powered up, creates the UV light (31) and sub-ultrasonic vibrations through the sensor (21) inside the container unit (20).

The invention utilizes UV rays from the UV light (31) to disinfect in combination with the functions of the magnetic strip (35) and the sensor (21) to vibrate the container unit (20) sub-ultrasonically. The time required (around 15 minutes) to clean and disinfect is drastically reduced.

Another feature worth mentioning is that the UV light (31) of the motorized unit (30) is placed in the positioning hole (114) of the upper compartment (111), the user only has to open the inner lid (12) to be able to replace the UV light (31). Plus, the elastic ring (33) on the positioning hole (114) under the UV light (31) can prevent accidental fluid spill from the upper compartment (111) to the lower compartment. (112).

The advantages of the aforesaid invention are as follows:
1. The temperature is maintained between 70 and 78 degrees by the function of the distributing crystal which shuts down after achieving cut-off point.
2. The program written into the CPU can precisely control the unit to prevent unseemliness and unstable frequencies.
3. The magnetic strip generates between 295 to 300 uH for strong liquid current.
4. The invention uses infrared for control, no need to worry for bad connection.
5. User only has to lift the inner lid to replace the UV light. Maintenance is easy.
6. After the invention is turned on, power is boosted to 40v by the capacitor and reduced to 20v after the UV light is turned on. The wait time to turn on the light is short and the intensity of the light is sufficient for disinfection.

It is of course to be understood that the embodiment described herein is merely illustrative of the principles of the invention and that a wide variety of modifications thereto may be effected by persons skilled in the art without departing from the spirit and scope of the invention as set forth in the claims.

1. A contact lens cleansing unit comprising:
a body proper, a container unit, and a motorized unit, of wherein, the body proper having an outer shell, an inner lid, a base, and an outer lid, the outer shell being divided into an upper and a lower compartment in between which is a positioning hole, the inner lid being placed on the upper compartment which has a frame for the container unit;
the container unit having a sensor and a lens rack placed within the frame on the upper compartment;
the motorized unit having a UV light and a circuit board placed in the lower compartment, the UV light being affixed in place to the positioning hole of the upper compartment, the circuit board having a power plug, diodes, a magnetic strip, capacitors, and an indicator light in which the positive and negative diodes are placed under the UV light for powering up the light through the capacitors while the magnetic strip is placed under the container unit;
by the action of the aforesaid invention, using UV light and sub-ultrasonic vibrations by the magnetic strip, cleaning, disinfecting, ease of replacing light bulb and convenience is achieved.

2. The contact lens cleansing unit as recited in claim 1, wherein the bottom of the upper compartment is connected to the lower compartment through a hollow tube on top of which are a first and second through holes while a plate is placed under the inner lid, the infrared control unit being placed within the hollow tube on top of which are two sensor controls in between which is a slot that matches the first through hole.

3. The contact lens cleansing unit as recited in claim 1, wherein under the UV light is an elastic ring fixed to the positioning hole.
